(19) United States
(12) Patent Application Publication
(10) Pub. No.: US 2007/0292760 A1
(43) Pub. Date: Dec. 20, 2007

(54) Lithium-ion storage battery comprising TiO2-B as negative electrode active material

(75) Inventors: Sebastien Patoux, Fontaine (FR); Carole Bourbon, Saint-Michel de Saint-Geoirs (FR); Frederic Le Cras, Notre Dame de L'Osier (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, PARIS (FR)

(21) Appl. No.: 11/806,398

(22) Filed: May 31, 2007

(30) Foreign Application Priority Data
Jun. 20, 2006 (FR) 06 05467

(51) Int. Cl. H01M 4/50; H01M 4/52

(52) U.S. Cl. 429/223; 429/231.1; 429/224

(57) ABSTRACT

The state of charge of a Li-Ion storage battery comprising a positive electrode active material presenting a constant lithium insertion/extraction potential over most of the capacity operating range and titanium oxide TiO₂ of bronze type structure as negative electrode active material can be easily monitored by simple reading of the operating voltage. The positive electrode active material is selected among LiNi_{0.5}Mn_{1.5}O₄ and derivatives thereof.

### BACKGROUND OF THE INVENTION

The invention relates to a Lithium-Ion storage battery.

### STATE OF THE ART

The Lithium-Ion technology, introduced onto the market in 1990, is currently widely implanted in the field of mobile applications (mobile telephony, portable computers, . . . ) where it is progressively replacing nickel-cadmium (NiCd) and metallic nickel-hydride (NiMH) storage batteries. This evolution can be explained by the continuous improvement of the performances of lithium storage batteries thus giving the latter much higher mass and volume energy densities than those proposed by the NiCd and NiMH battery types.

Unlike the negative electrode of a Lithium-Metal battery, the negative electrode of a Lithium-Ion battery (also called Li-ion) does not constitute a lithium source for the positive electrode. Thus, in a Lithium-Ion system, the negative electrode generally comprises a lithium intercalation or insertion material such as carbon in graphite form, and the lithium comes from the active material of the positive electrode. The Li+ cations then go back and forth between the respectively negative and positive electrodes, each time the storage battery is charged and discharged. The lithium is therefore never in metallic form in a Li-ion storage battery.

The currently marketed Li-ion technology is based on reversible intercalation of lithium coming from an active material of the positive electrode in the graphite which forms the active material of the negative electrode. The active material of the positive electrode is generally a lamellar oxide of the LiCoO₂, LiNiO₂ and mixed oxides Li(Ni, Co, Mn, Al)O₂ type or a compound of spinel structure with a composition close to LiMn₂O₄. In such a Li-Ion system, monitoring of the state of charge is made possible by monitoring the voltage delivered.

This Li-Ion system, and in particular the lamellar oxide and graphite based system, has henceforth reached maturity for mobile applications. However, it is not suitable for applications presenting much greater energy requirements, such as electric or hybrid vehicles, stationary applications and renewable energies. Active materials and in particular lamellar oxides do in fact present a high cost and they give rise to safety problems since the lamellar phases and the graphite are relatively unstable, respectively in the charged state and in the discharged state. Moreover, the use of graphite as active material for the negative electrode imposes a limitation on the current density, in particular at the end of charging. The graphite of the negative electrode of Li-Ion batteries does in fact present an operating potential (˜100 mV vs. Li+/Li) very close to that of metal lithium deposition. Lithium dendrites can therefore occasionally form, which is liable to cause short-circuits and an explosion, all the more so the higher the current density and as a constant current is maintained at the end of charging. To avoid this problem, specific charging protocols have been developed for commercial graphite-base storage batteries.

Recent electrode material developments propose replacing the graphite of the negative electrode by lithiated titanium oxide Li₄Ti₅O₁₂. The lithium insertion/extraction reaction in the Li₄Ti₅O₁₂/Li₇Ti₅O₁₂ couple is the following:

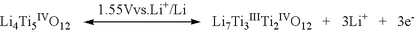

This reaction is two-phase, i.e. it presents a constant insertion/extraction potential compared with the insertion/extraction potential of the Li⁺/Li couple. The insertion/extraction potential of a material with respect to the insertion/extraction potential of the Li⁺/Li couple is also called, in simplified manner, lithium insertion/extraction potential or operating potential of the electrode. As represented in FIG. 1, the insertion/extraction potential of the lithium of the Li₄Ti₅O₁₂/Li₇Ti₅O₁₂ couple (Curve B) is equal to 1.55 Volts compared with the insertion/extraction potential of the Li⁺/Li couple (Curve A), i.e. 1.55 V vs. Li⁺/Li. Such a potential enables the risk of formation of dendrite to be overcome. In addition, the Li₄Ti₅O₁₂ compound enables three moles of lithium ions to be inserted reversibly at said potential. Li₄Ti₅O₁₂ moreover presents a high chemical and thermal stability, it is non-toxic and it presents a great electrochemical efficiency . . . The chemistry of titanium moreover enables a whole range of morphologies (texture, size . . . ) of Li₄Ti₅O₁₂ to be achieved, in particular of nanometric size. This can enable high-speed insertion/extraction, and therefore a use for power applications. Li₄Ti₅O₁₂ is therefore a material that is able to replace graphite as negative electrode material in certain applications.

Developments are also in progress for the active material of the positive electrode. Thus, lithiated iron phosphate LiFePO₄, of olivine structure, has for some years now been considered as a good choice of positive electrode material for certain new applications, such as hybrid automobiles, portable tools or photovoltaic systems. Extraction of lithium in LiFePO₄ takes place according to the following reversible two-phase process:

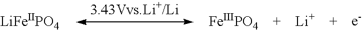

The specific capacity of the material is 170 mAh/g at a lithium insertion/extraction potential of 3.4 V vs. Li⁺/Li (curve C in FIG. 1). The theoretical mass energy density of LiFePO₄, which corresponds to the value of the specific capacity multiplied by the potential lithium insertion/extraction value of the LiFePO₄/FePO₄ couple (i.e. 3.43 V vs. Li⁺/Li) is in the region of 580 Wh/kg and is therefore higher than the practical value obtained with LiCoO₂ and other commercial lamellar oxides (typically 530 Wh/kg). This compound can therefore be considered as constituting a credible alternative to LiCoO₂ and its derivatives on the Li-Ion storage battery market. The theoretical performances can moreover practically be achieved, in particular by making a special coating of the LiFePO₄ particles with carbon, LiFePO₄ being a relatively poor electronic conductor, so as to obtain a composite material LiFePO₄/C. The use of LiFePO₄ in a lithium storage battery proves of very great interest not only on account of the intrinsic performances of the LiFePO₄ material but also on account of its great thermal and chemical stability, its low toxicity and its moderate cost compared with that of cobalt or nickel compounds for example.

At a less advanced stage, high-voltage, high-energy spinel oxides of the LiNi_{0.5}Mn_{1.5}O₄ type are also being studied with the aim of replacing commercial lamellar oxides in the future. The spinel-structure compound LiNi^{II}_{0.5}Mn^{IV}_{1.5}O₄, is electrochemically active in reversible manner at a potential of about 4.7 V vs. Li⁺/Li (curve D, FIG. 1). The charge/discharge reaction (lithium extraction/insertion) of the LiNi_{0.5}Mn_{1.5}O₄/Ni_{0.5}Mn_{1.5}O₄ couple takes place according to the following reversible two-phase process:

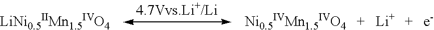

In addition, its theoretical specific capacity is 146.7 mAh/g, thus giving it a theoretical mass energy density of 692.4 Wh/kg for a mean potential of 4.72 V vs. Li⁺/Li.

On account of the advantageous properties of LiFePO₄ and Li₄Ti₅O₁₂, associating a LiFePO₄-base positive electrode and a Li₄Ti₅O₁₂-base negative electrode has for example been reported in the article “Optimized Lithium Iron Phosphate for High-Rate Electrochemical Applications” (Journal of The Electrochemical Society, 151(7) A1024-A1027 (2004)) by S. Franger et al. This type of Li-Ion storage battery is in fact very interesting as it uses non-toxic materials of great robustness, with in particular an extended lifetime, which are stable and able to operate in high current states with moderate capacity losses in comparison with a cycling at low current densities.

The LiFePO₄/Li₄Ti₅O₁₂ couple therefore meets with great favour due to the intrinsic performances of the two compounds. However, as represented in FIGS. 1 and 2, LiFePO₄ at the positive electrode and Li₄Ti₅O₁₂ at the negative electrode each have a constant lithium insertion/extraction potential over most of the capacity operating range. Associating them therefore gives rise to a constant operating voltage (1.88V) over most of the capacity operating range. In FIG. 2, the voltage/capacity specific curve of the Li-Ion storage battery comprising a Li₄Ti₅O₁₂-base negative electrode and a LiFePO₄-base positive electrode, in charge/discharge state equivalent to C/5, shows that the capacity of the storage battery coincides perfectly with the practical capacities obtained on the isolated materials, tested in Li-Metal configuration (FIG. 1). The operating voltage is constant over most of the capacity operating range (between about 10% and 90% of the specific capacity). However, for future marketing purposes, this feature constitutes a large drawback as it is impossible to determine the state of charge (or discharge) at a given moment by simply reading the voltage, as is the case with the lithium storage batteries currently on the market. The user of the Li-Ion storage battery comprising the LiFePO₄/Li₄Ti₅O₁₂ couple or the electronic charge management system of said storage battery can therefore not estimate the state of charge and thereby know if the energy of the storage battery has to be saved or if it has to be recharged quickly. A similar problem is also likely to occur with any other positive electrode material presenting a constant operating potential. This is in particular the case for LiNi_{0.5}Mn_{1.5}O₄ and derivatives thereof, as shown in FIG. 3.

### OBJECT OF THE INVENTION

The object of the invention is to provide a Lithium-Ion storage battery remedying the shortcomings of the prior art. More particularly, the object of the invention is to provide a Lithium-Ion storage battery with a state of charge that is easy to check and which is suitable for applications presenting large energy requirements.

According to the invention, this object is achieved by the accompanying claims.

### BRIEF DESCRIPTION OF THE DRAWINGS

Other advantages and features will become more clearly apparent from the following description of particular embodiments of the invention, given for non-restrictive example purposes only and represented in the accompanying drawings, in which:

FIG. 1 represents the voltage curves versus the ratio between the specific capacity and the theoretical capacity (charge/discharge regime equivalent to C/5) of a Lithium-Metal storage battery comprising a respectively Li-based (Curve A), Li₄Ti₅O₁₂-based (Curve B), LiFePO₄-based (Curve C) and LiNi_{0.5}Mn_{1.5}O₄-based (Curve D) positive electrode.

FIG. 2 represents a voltage/specific capacity curve (charge/discharge regime equivalent to C/5) of a Li-ion storage battery comprising a Li₄Ti₅O₁₂-based negative electrode and a LiFePO₄-based positive electrode.

FIG. 3 represents a voltage/specific capacity curve (charge/discharge regime equivalent to C/5) of a Li-Ion storage battery comprising a Li₄Ti₅O₁₂-based negative electrode and a LiNi_{0.5}Mn_{1.5}O₄-based positive electrode.

FIG. 4 represents a voltage/specific capacity curve (charge/discharge regime equivalent to C/5) of a Lithium-Metal storage battery comprising a TiO₂-B-based positive electrode synthesized according to a particular embodiment.

FIG. 5 represents the voltage curve versus the state of charge obtained in galvanostatic mode cycling (charge/discharge regime equivalent to C/5) of a Li-Ion storage battery comprising a LiNi_{0.5}Mn_{1.5}O₄-based positive electrode and a negative electrode based on TiO₂-B synthesized according to the first embodiment.

FIG. 6 represents a voltage/specific capacity curve (charge/discharge regime equivalent to C/5) of a Lithium-Metal storage battery comprising a positive electrode based on TiO₂-B synthesized according to an alternative embodiment.

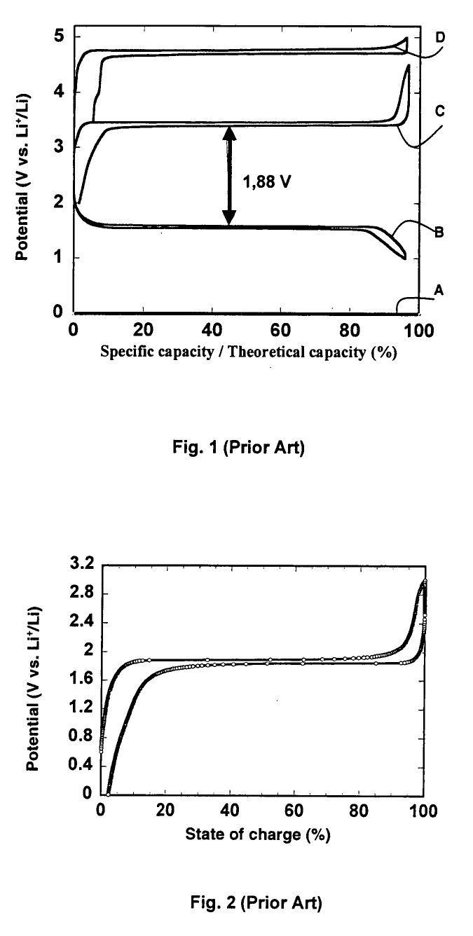

### DESCRIPTION OF PARTICULAR EMBODIMENTS

The state of charge of a Li-Ion storage battery comprising:

a positive electrode active material presenting a constant lithium insertion/extraction potential over most of the capacity operating range and selected among LiNi_{0.5}Mn_{1.5}O₄ and derivatives thereof,

and titanium oxide TiO₂ of bronze type structure, also called TiO₂-B, as negative electrode active material,

can easily be checked by a simple reading of the operating voltage.

Indeed, unlike the lithium storage battery comprising Li₄Ti₅O₁₂ as negative electrode material and a positive electrode active material presenting a constant lithium insertion/extraction potential over most of the capacity operating range (for example LiFePO₄ or LiNi_{0.5}Mn_{1.5}O₄ and derivatives thereof), a Li-Ion storage battery with TiO₂-B as negative electrode active material presents an operating potential continually varying according to the state of charge (or discharge). As the operating potential of the positive electrode is constant over most of the capacity operating range, the voltage delivered by the storage battery also varies continuously according to the state of charge or discharge of said storage battery and measuring it enables said state to be checked.

Moreover, bronze type titanium oxide presents at least equal electrochemical performances to those obtained with a Li₄Ti₅O₁₂-based negative electrode. Indeed, among the numerous structural varieties of titanium oxide (rutile, anatase, . . . ), the bronze type structure presents the advantage of having an open three-dimensional structure forming channels, as reported in the article “TiO₂(B) a new form of titanium dioxide and the potassium octatitanate K₂Ti₈O₁₇” (Material Research Bulletin Vol. 15, p 1129-1133, 1980) by Rene Marchand et al., or the international patent application WO2006/033069 which also mentions the possibility of forming an electrochemical cell with TiO₂-B and LiFePO₄ respectively as negative and positive electrode materials. Such channels are propitious for insertion and extraction of lithium. Thus, when a TiO₂-B-based lithium storage battery is operating, the lithium insertion reaction in TiO₂-B leads to composition of LiₓTiO₂-B in which at least 0.6 mole of lithium ions can be inserted and then extracted. In a general manner, the lithium insertion/extraction reaction in TiO₂-B is written:

Li-A+TiO₂ [symbol] Li₁₋ₓA+LiₓTiO₂

where Li-A corresponds to the active material of the positive electrode.

The active material of the positive electrode is a material presenting a constant lithium insertion/extraction potential over most of the capacity operating range. Thus, the active material of the positive electrode is selected among LiNi_{0.5}Mn_{1.5}O₄ and derivatives of LiNi_{0.5}Mn_{1.5}O₄. Among the derivatives of LiNi_{0.5}Mn_{1.5}O₄, the active material can for example be in accordance with the following formula: Li₁₋ₐNi_{0.5-b}Mn_{1.5-c}O_{4-d}, with a, b, c and d comprised between −0.1 and +0.1. What is meant by a, b, c and d comprised between −0.1 and +0.1 is that each of the parameters a, b, c and d is greater than or equal to −0.1 and smaller than or equal to +0.1. More particularly, the active material can be a derivative of LiNi_{0.5}Mn_{1.5}O₄ in accordance with the following general formula:

LiNi_{0.5-x}Mn_{1.5+x}O_{4-d}, with −0.1≦x≦0.1 and d≦+0.1

LiNi_{0.5}Mn_{1.5}O₄ and its derivatives, like LiFePO₄, present a constant lithium insertion/extraction potential over most of the capacity operating range. The materials presenting this characteristic are also called dual phase materials. LiNi_{0.5}Mn_{1.5}O₄ on the other hand presents the advantage, compared with LiFePO₄, of having a higher lithium insertion/extraction potential. In FIG. 1, it can in fact be seen that the lithium insertion/extraction potential of LiFePO₄ is constant at a value of about 3.43V, on charge and on discharge, over the interval 10-90% of the ratio between the specific capacity and the theoretical capacity (curve C) whereas that of LiNi_{0.5}Mn_{1.5}O₄ is about 4.7V, on charge and on discharge, over the same interval (curve D). The high potential of the spinel oxide LiNi_{0.5}Mn_{1.5}O₄ does however give it a high energy density and enables Li-Ion storage batteries with a high mass energy density (about 200-220 Wh/kg for LiNi_{0.5}Mn_{1.5}O₄ against 140-160 Wh/kg with LiFePO₄) and volume energy density to be produced. In addition, the mean operating voltages of such storage batteries are about 1.7-1.8 V for the LiFePO₄/TiO₂-B couple and about 3.0-3.1 V for the LiNi_{0.5}Mn_{1.5}O₄/TiO₂-B couple.

The lithium insertion/extraction reaction in TiO₂-B takes place at a mean potential of about 1.6 V vs. Li⁺/Li and it is generally perfectly reversible. The corresponding experimental specific capacity is about 200 mAh/g. Thus, for the theoretical value x=1 corresponding to the total reaction of reduction of Ti⁴⁺ into Ti³⁺, the theoretical specific capacity of a TiO₂-B-based storage battery is 335 mAh/g whereas, for a Li₄Ti₅O₁₂-based storage battery, it is 175 mAh/g.

The gain in intrinsic capacity obtained by replacing Li₄Ti₅O₁₂ by TiO₂-B makes it possible for example to use thinner electrodes, which therefore give better performances power-wise, while maintaining an equivalent global capacity of the storage battery. In addition, unlike Li₄Ti₅O₁₂, the bipolar technology described in the patent application WO03/047021 is perfectly applicable to TiO₂-B on account of its higher operating potential at 1 V vs. Li⁺/Li.

Synthesis of TiO₂-B can be performed by any type of known synthesizing methods. Certain synthesizing methods enable for example a TiO₂-B to be achieved in the form of grains of micrometric or nanometric size. In addition, the synthesis can also be chosen according to a predetermined type of grain morphology. It may in fact be advantageous to choose a particular TiO₂-B grain morphology as the electrochemical properties of said material vary substantially with the morphology of the grains, in particular in terms of practical specific capacity and more or less pronounced variation of the operating potential, in the course of the lithium insertion/extraction reaction. More particularly, it is possible to synthesize TiO₂-B particles without any particular shape or in the form of nanowires or nanotubes as reported in the article “Lithium-Ion Intercalation into TiO₂-B nanowires” (Advanced Materials, 2005, 17, No. 7, p 862-865) by A. Robert Armstrong et al. and in the article “Nanotubes with the TiO₂-B structure” (Chem. Commun., 2005, p 2454-2456) by Graham Armstrong et al.

Preferably, the different synthesizing methods employed are chosen to enable Li-Ion storage batteries with good performances to be achieved, with a mean operating voltage of about 1.6 V vs. Li⁺/Li and varying in more or less pronounced manner according to the state of charge of said storage battery. More particularly, the operating voltage of the storage battery varies in increasing manner with respect to the state of charge.

In practical manner, the positive and negative electrodes of the Li-Ion storage battery according to the invention can be fabricated by any type of known means. For example, the active material of each electrode can be put in the form of an intimate dispersion, in aqueous or organic solution, with an electronic conducting additive such as carbon and a binder designed to provide a good ionic conduction and a satisfactory mechanical strength. The binder can be an organic binder, such as polyethers, polyester, a methyl methacrylate-base polymer, acrylonitrile, or vinylidene fluoride. The binder can also be a component soluble in water such as natural or synthetic rubber. The dispersion, when it is aqueous, can also comprise a thickener, for example of carboxymethyl cellulose, hydroxypropyl, or methyl cellulose type, and/or a surface active agent and/or a salt (LiOH for example). The dispersion, also called “ink”, is then deposited on a metal foil sheet, for example made of aluminium and acting as current collector. The electronic conducting additive can be carbon.

The fact that TiO₂-B presents an operating potential higher than 1 V vs Li⁺/Li presents the advantage of limiting and even preventing degradation of the electrolyte at the interface between the TiO₂-B and the electrolyte. The choice of electrolyte can therefore be of any known type. It can for example be formed by a salt comprising at least the Li⁺ cation. The salt is for example selected among LiClO₄, LiAsF₆, LiPF₆, LiBF₄, LiR_{F}SO₃, LiCH₃SO₃, LiN(R_{F}SO₂)₂, LiC(R_{F}SO₂)₃, LiTFSI, LiBOB, and LiBETI, RF being selected among a fluorine atom and a perfluoroalkyl group comprising between one and eight carbon atoms. LiTFSI is the acronym for lithium trifluoromethanesulfonylimide, LiBOB that of lithium bis(oxalato)borate, and LiBETI that of lithium bis(perfluoroethylsulfonyl)imide. The electrolyte salt is preferably dissolved in an aprotic polar solvent such as ethylene carbonate, propylene carbonate, dimethyl carbonate, ethyl methyl carbonate, etc. The electrolyte can be supported by a separating element arranged between the two electrodes of the storage battery, the separating element then being imbibed with electrolyte. Preferably, the electrolyte is chosen such as to present a good thermal stability, the highest possible ionic conductivity, the lowest toxicity and the least cost. In all cases, the electrolyte must be stable at the operating potentials of the two electrodes or it must develop a relatively stable passivation layer at the electrode/electrolyte interface, in the course of the first charge/discharge cycle, which layer is not insulating from an ionic point of view. Likewise, the electrolyte must be chemically stable with respect to the electrode materials with which it is in contact.

For comparative example purposes, two Li-Ion storage batteries, noted batteries A and B, were produced and tested. Batteries A and B each comprise a negative electrode having a particular active material as base.

For battery A, the active material of the negative electrode is Li₄Ti₅O₁₂. It is for example prepared by mixing 201.05 grams of TiO₂ of anatase variety (Huntsman) with 76.11 grams of Li₂CO₃ (Aldrich) for two hours in a planetary mill in the presence of heptane. After drying, the homogenate is heated to 500° C. for 15 hours, and then to 680° C. for 15 hours and finally to 900° C. for 5 hours. It is then homogenized in a planetary mill for one hour, and then heated again to 900° C. for 5 hours. Final milling is then performed for 24 hours before the powder obtained is heated directly to 500° C. for 15 minutes in a sealed quartz tube under argon and is then rapidly cooled to ambient temperature. The X-ray diffraction diagram performed on said powder enables the presence of the pure and well crystallized Li₄Ti₅O₁₂ compound to be confirmed.

For battery B, the active material of the negative electrode is a TiO₂-B compound synthesized by hydrolysis of potassium tetratitanate, as described in the article “TiO₂(B) a new form of titanium dioxide and the potassium octatitanate K₂Ti₈O₁₇” (Material Research Bulletin Vol. 15, p 1129-1133, 1980) by Rene Marchand et al. More particularly, 14.81 grams of potassium nitrate (KNO₃; Merck) are mixed in a mill with 23.17 grams of anatase variety titanium oxide (TiO₂-anatase; Huntsman). After milling, the mixture is heated to 1000° C. for 24 hours so as to obtain the compound K₂Ti₄O₉. This compound is then placed in an acidified aqueous solution (for example HNO₃ at 3 mol/L) and the whole mixture is mechanically stirred for 12 hours at ambient temperature. The powder obtained is then washed several times in demineralized water and then heated to 400° C. for 3 hours to obtain a titanium oxide TiO₂ of “Bronze” type structural form. The size of the TiO₂-B particles is micrometric.

In order to determine the electrochemical performances of the TiO₂-B synthesized in this way, a Lithium-Metal storage battery of the “button cell” type is produced with:

a lithium negative electrode in the form of a disk with a diameter of 16 mm and a thickness of 130 μm deposited on a nickel disk acting as current collector,

a positive electrode formed by a disk with a diameter of 14 mm taken from a composite film with a thickness of 25 μm comprising 80% in weight of TiO₂-B compound as produced above, 10% in weight of carbon black and 10% in weight of polyvinylidene hexafluoride, the disk being deposited on an aluminium foil strip with a thickness of 20 micrometers acting as current collector,

a separator imbibed with the LiPF₆ salt-base liquid electrolyte (1 mol/L) in solution in a mixture of ethylene carbonate and dimethyl carbonate. As represented in FIG. 4, at 20° C., under C/5 conditions, this system delivers a stable capacity of about 200 mAh/g, i.e. 60% of the theoretical capacity; that is to say more than in the case of Li₄Ti₅O₁₂ (theoretical capacity equal to 175 mAh/g). Moreover, unlike curve A of FIG. 1, the lithium insertion/extraction potential of TiO₂-B is not constant over most of the specific capacity operating range.

The two storage batteries A and B also each comprise a LiNi_{0.5}Mn_{1.5}O₄-base positive electrode and a separating element marketed under the name of Celgard 2400 and imbibed with liquid electrolyte.

The liquid electrolyte is formed by 1 mol/L of LiPF₆ in solution in a mixture of propylene carbonate, dimethyl carbonate and ethylene carbonate.

Furthermore, the active material of the positive electrode, LiNi_{0.5}Mn_{1.5}O₄, is prepared by intimate blending of 10.176 g of nickel carbonate, 6.066 g of lithium carbonate and 29.065 g of manganese carbonate under stoichiometric conditions, with an excess of 3% molar of Li. The intimate blending is performed in a Retsch planetary mill comprising a 250 ml bowl with 13 to 15 balls 20 mm in diameter and each weighing 10.8 g, for 20 hours at 500 rpm, in the presence of hexane (submerged powder). The mixture is then dried overnight at 55° C. before being subjected to thermal treatment at 600° C. for 10 hours, and then at 900° C. for 15 hours. Cooling to ambient temperature at the rate of 0.1°/min is then performed. X-ray diffraction analysis enables the formation of the LiNi_{0.5}Mn_{1.5}O_{4-d} compound to be observed, with d close to 0, the unit cell parameter of said compound being 8.167 Angstroms.

The electrodes of the storage batteries A and B are each produced by mixing 80% in weight of active material, 10% in weight of carbon black acting as electronic conducting material, and 10% in weight of polyvinylidene hexafluoride acting as binder. The mixture is then deposited on an aluminium current collector.

The two storage batteries A and B were tested at 20° C., with a five-hour charge and discharge cycle (C/5 conditions).

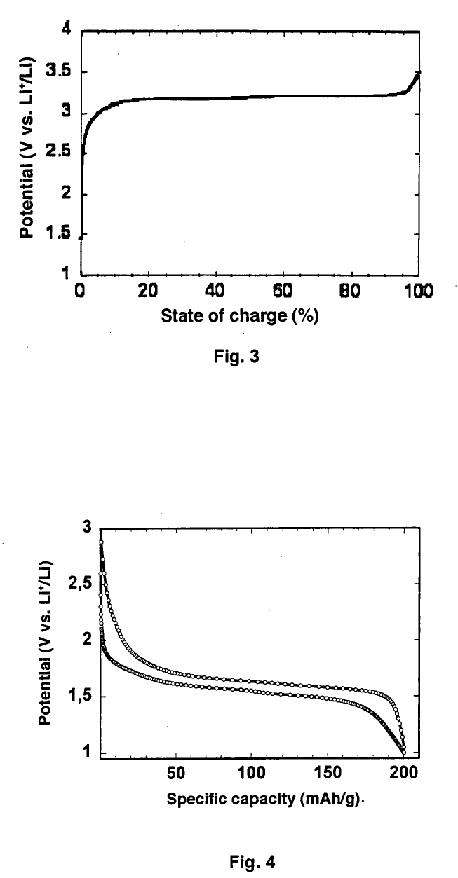

Battery A enables lithium ions to be exchanged at a fixed potential of 3.2 V over most of its capacity operating range. Thus, as represented in FIG. 3, it is not possible to monitor the state of charge of battery A by simply reading the operating voltage of battery A, as the latter remains substantially constant over most of the state of charge or discharge range, and more particularly between 10% state of charge and 90% state of charge.

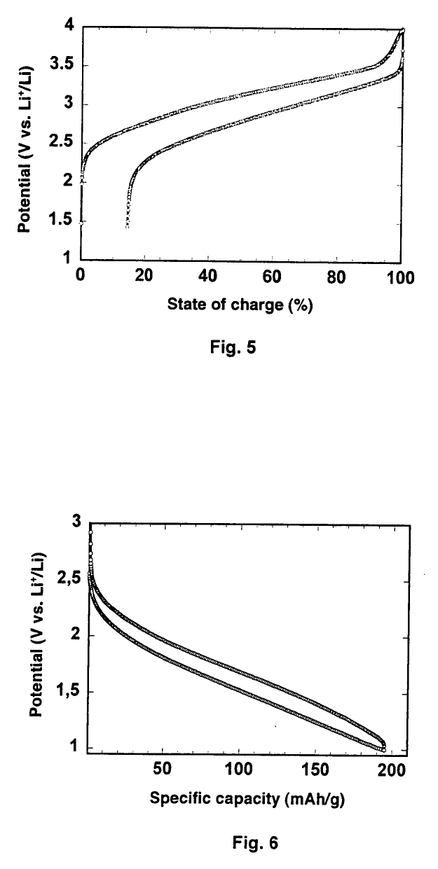

On the contrary, battery B enables lithium ions to be exchanged in the potential range of about 1.5V-4V (FIG. 5). Its state of charge can therefore be perfectly well monitored by simple reading of the potential.

It is possible, due to an intrinsically higher specific capacity of the TiO₂-B-base negative electrode compared with the Li₄Ti₅O₁₂-base one, to use a smaller weight of negative electrode for a storage battery whose base is formed by the LiNi_{0.5}Mn_{1.5}O₄/TiO₂-B couple than that in the case of a storage battery whose base is formed by the LiNi_{0.5}Mn_{1.5}O₄/Li₄Ti₅O₁₂ couple with the same overall capacity.

According to an alternative embodiment, titanium oxide TiO₂ of “Bronze” type structural form can be produced by means of another synthesizing method than that used in the case of battery B. For example, TiO₂-B can be synthesized by hydrothermal means as reported in the above-mentioned article “Nanotubes with the TiO₂-B” by G. Armstrong et al. More particularly, 5 g of TiO₂ in anatase form (Huntsman) are placed in 84 mL of soda at 15 mol/L. The mixture is stirred for 1 hour and is then placed in a teflon autoclave cell (PARR vessel—125 mL), which is then placed in an oven at 170° C. for 68 hours. The mixture is then removed, washed twice in distilled water and centrifuged. The isolated powder is then placed in 1 L of distilled water containing 0.05 mol/L of hydrochloric acid (stirred for 2 h). After decanting, the recovered powder is again washed twice and centrifuged. Finally, a titanium oxide TiO₂ of “Bronze” type structural form is obtained, after drying in a vacuum at 80° C. for 24 hours.

This synthesizing method enables a bronze type titanium oxide to be achieved presenting different morphological specificities from the oxide produced for battery B. The TiO₂-B particles are partially in the form of nanowires and partially in the form of agglomerated amorphous particles of different sizes.

In order to determine the electrochemical performances of TiO₂-B, a Lithium-Metal storage battery of the “button cell” type is produced in the same way as in the previously described Lithium-Metal storage battery, the bronze type titanium oxide obtained by hydrolysis of the potassium tetratitanate being replaced by that obtained by hydrothermal means.

As represented in FIG. 6, at 20° C., under C/5 conditions, this Lithium-Metal storage battery also delivers a stable capacity of about 200 mAh/g. The variation of the operating voltage versus the specific capacity is on the other hand faster for the bronze type titanium oxide produced by hydrothermal means than for that produced by hydrolysis of potassium tetratitanate.

1. Lithium-Ion storage battery comprising at least:
a positive electrode active material presenting a constant lithium insertion/extraction potential over most of the capacity operating range and selected from the group consisting of LiNi_{0.5}Mn_{1.5}O₄ and derivatives of LiNi_{0.5}Mn_{1.5}O₄
and a negative electrode active material formed by titanium oxide TiO₂ of bronze type structure.

2. Storage battery according to claim 1, wherein the derivatives of LiNi_{0.5}Mn_{1.5}O₄ are of the Li₁₋ₐNi_{0.5-b}Mn_{1.5-c}O_{4-d} type, with a, b, c and d comprised between −0.1 and +0.1.

3. Storage battery according to claim 2, wherein the derivatives of LiNi_{0.5}Mn_{1.5}O₄ are of the LiNi_{0.5-x}Mn_{1.5+x}O_{4-d} type, with −0.1≦x≦0.1 and d≦+0.1.

4. Storage battery according to claim 1, comprising a separator imbibed with liquid electrolyte comprising a salt with at least the Li⁺ ion as cation.
